(19) United States
(12) Patent Application Publication
(10) Pub. No.: US 2018/0354581 A1
(43) Pub. Date: Dec. 13, 2018

(54) CONTROL DEVICE FOR A BICYCLE

(71) Applicant: BLOKS. AG, Schaan (LI)

(72) Inventor: Daniel MEERMANN, Munchen (DE)

(73) Assignee: BLOKS. AG, Schaan (LI)

(21) Appl. No.: 15/754,840

(22) PCT Filed: Aug. 26, 2016
(86) PCT No.: PCT/EP2016/070227

§ 371 Date: Feb. 23, 2018

(30) Foreign Application Priority Data
Aug. 26, 2015 (DE) 10 2015 216 346.6

(51) Int. Cl. B62M 6/50; B62M 9/122; B62M 9/132

(52) U.S. Cl. CPC B62M 6/50; B62J 2099/0013; B62M 9/132; B62M 9/122

(57) ABSTRACT

The invention relates to a control device for a bicycle having at least one device that influences the driving properties of the bicycle, wherein
the control device has an electronic controller configured
to execute in parallel a first operating system (OS1) and a second operating system (OS2), wherein
on the first operating system (OS1) during intended operation of the control device, at least one application is executed for controlling and/or monitoring the device that influences the driving properties of the bicycle, and
on the second operating system (OS2), user-specific applications are executed during intended operation of the control device.

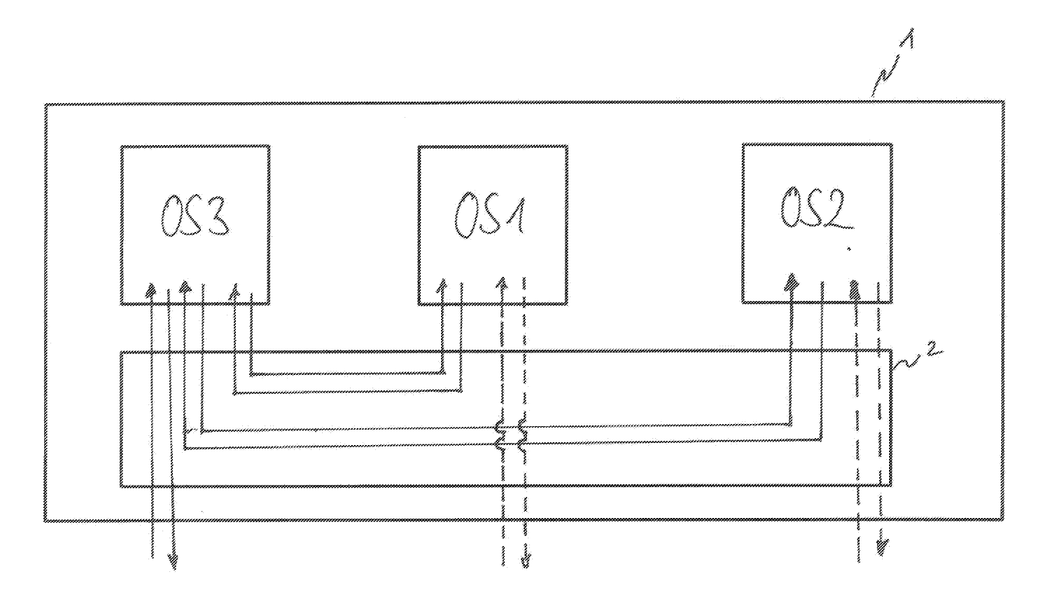

The invention relates to a control device for a bicycle.

From the prior art, control devices for bicycles are known that control, for example, an electric drive unit of the bicycle or an electric gear shifting of the bicycle.

An object of the invention is to provide at least a control device that can perform more diverse functions and applications. Moreover, it is an object of the present invention to provide a control device for a bicycle that ensures a stable and robust execution of applications and performance of functions.

This object is achieved by a control device according to claim 1. Preferred embodiments are the subject of the dependent claims.

The basic idea of the invention is to provide multiple operating systems on the control device that are executed in parallel and to which different key tasks are assigned.

A control device according to an aspect of the invention is provided for a bicycle having at least one device that influences the driving properties of the bicycle, the control device having an electronic controller that is configured to

execute a first operating system and a second operating system in parallel, wherein

at least one application for controlling and/or monitoring the device that influences the driving properties of the bicycle is executed on the first operating system during intended operation of the control device, and

on the second operating system (OS2), user-specific applications are executed during intended operation of the control device.

The devices that influence the driving properties of the bicycle are in particular an electric drive unit provided to support the drive of the bicycle, or an electric gear shift.

The applications executed on the first operating system for controlling these devices can control, for example, the power of the electric drive unit—the degree of support—or a selection of a gear.

Applications for monitoring this device include, for example, measuring the charge status of a battery provided for the electric drive unit, determining the current load state of the electric drive unit, determining the gear currently in use, and/or the like.

It is possible that multiple applications are executed on the first operating system during intended operation of the control device, each being executed to control or monitor one of a plurality of devices influencing the driving properties of the bicycle.

The user-specific applications that are executed on the second operating system can be, for example, user-installed applications such as apps. Concrete examples are navigation systems and Internet applications.

In addition, one or more applications that perform safety-relevant functions can additionally be executed on the first operating system during intended operation of the control device.

These include, for example, applications for determining the current speed of the bicycle, for determining the functionality of the brakes, tire pressure, and/or the like.

Preferably, the control device has an interface to which the devices(s) for the exchange/receipt of control data and/or monitoring data can be connected.

In addition, there can be connected to the interface:

one or more sensors providing additional control data or monitoring data necessary for the control and/or monitoring of the device(s); and/or

one or more sensors that provide safety-relevant data necessary for performing the safety-relevant functions; and/or

one or more input devices via which the user can enter control instructions for controlling the device(s) that are passed to the interface in the form of corresponding command data; and/or

one or more input devices via which the user can enter setting instructions for setting the user-specific applications that are passed to the interface in the form of corresponding setting data; and/or

one or more communication adapters for entering communication signal data providing the communication data necessary for executing the user-specific applications; and/or

one or more display devices for displaying information data outputted from the first and/or second operating system; and/or

one or more devices for generating haptic feedback and/or audio feedback.

The sensors can be, for example, a speed sensor, measuring sensors for measuring the charge status of the battery, sensors for determining the engaged gear, sensors for measuring the force acting on a foot pedal of the bicycle, camera sensors, acceleration and tilt sensors, compass sensors, pressure sensors, ultrasonic sensors, and/or the like.

The above-mentioned input devices can be, for example, a remote control (e.g. in the form of a touch sensor) for issuing the control instructions. The communication adapters can be, for example, GPS, Bluetooth, WiFi, or GSM adapters.

Preferably, the electronic controller of the control device is configured to execute a third operating system (OS3) on which system-specific applications are executed.

The system-specific applications include the interface application explained further below, a watchdog application, and an update application for updating the applications running on the operating systems.

Preferably, the system-specific applications executed on the third operating system control the first and/or second operating system.

For example, the system-specific applications that are executed on the third operating system for controlling the first and/or second operating system include the following applications:

(i) a watchdog application that monitors the first operating system and/or the second operating system and, depending on this, can change, end and/or start the first and/or second operating system itself and/or applications that are executed on the first or second operating system; and/or

(ii) an interface application that controls the data communication

between the first and/or second operating system and the device(s), and/or

between the first and/or second operating system and the sensor, and/or

between the first and/or second operating system and the input device(s), and/or

between the first and/or second operating system and the communication adapter;

(iii) an access rights application that defines the data to which the first and/or second operating system has access.

Preferably, the interface application is configured to perform an authentication of the first and/or second operating system and to prohibit the data communication when the authentication fails.

This, for example, prevents the first operating system and the second operating system from being “rooted” by a user by only simulating the behavior of the first and second operating systems toward the third operating system.

Also preferably, the control device includes a virtualization layer, preferably a hypervisor, at least between the electronic controller and a first virtual machine on which the first operating system is running, and a second virtual machine on which the second operating system is running, wherein

the third operating system for controlling the first and/or second operating system is configured to control the virtualization layer.

Particularly preferably, the virtualization layer is also located between the electronic controller and a third virtual machine on which the third operating system is running, wherein the third operating system for controlling the first and/or second operating system is configured to control the virtualization layer.

The electronic controller includes, for example, a CPU (central processing unit) having a single processor core, wherein the virtualization layer assigns corresponding resources to each virtual machine.

The electronic controller preferably includes, however, a CPU (central processing unit) having a plurality of processor cores, wherein the virtualization layer assigns at least one processor core to each virtual machine.

Particularly preferably, the first operating system is assigned a single processor core, the second operating system two processor cores, and the third operating system in turn a single processor core.

The watchdog application monitors the first operating system and/or the second operating system by monitoring a load of the processor core of the first virtual machine and/or the second virtual machine, and depending on this changes, ends and/or starts the first and/or second operating system itself and/or applications that are executed on the first and/or second operating system.

Preferably, the interface application controls the data communication by correspondingly controlling the virtualization layer.

The third operating system further preferably provides an internal interface for the first and second operating systems, wherein the interface application is configured such that at least the data communication, which contains the control data and safety-relevant data, is carried out exclusively via the internal interface.

The other data can also be communicated via the internal interface, but it is alternatively also possible for these data to be delivered to the first and second operating systems directly; however, the first and second operating systems can process said data only after verification by the third operating system.

Preferably, the interface application controls the data communication by controlling the virtualization layer in such a way that data in an interface memory assigned by the virtualization layer to the first and/or the second virtual machine are checked before transmission to the respective operating system.

Finally, the virtualization layer assigns to the first operating system a first virtual frame memory for storing the corresponding information data and to the second operating system a second virtual frame memory for storing the corresponding information data, wherein the virtualization layer merges the information data from the first and second frame memories in a third frame memory prior to output to the display device for shared display on the display device. In this connection, the virtualization layer can also process signals for the devices for producing the audio feedback and/or the haptic feedback via corresponding caches.

Below, a preferred embodiment of the invention is explained with reference to the accompanying FIGURE, said FIGURE showing a schematic block diagram of the control device according to the invention.

The accompanying FIGURE shows a control device 1 according to the invention intended to be installed in a bicycle having at least one device influencing the driving characteristics of the bicycle. The device mentioned can be, for example, an electric drive unit that performs the function of an electric drive support, or an electric gear shift.

The control device 1 has a virtualization layer 2, which the electronic controller (hardware) preferably assigns to three virtual machines.

The basic idea is to execute two or more operating systems having different key tasks in parallel. In this preferred embodiment, three operating systems OS1, OS2, OS3 are installed on the control device 1.

For this purpose, the virtualization layer 2 (preferably a hypervisor) abstracts the underlying hardware or electronic controller (not shown) for implementing the plurality of virtual machines, wherein each of the operating systems is installed on one of the virtual machines.

Preferably, the hardware or electronic controller includes a CPU having multiple processor cores, wherein the virtual machine for the operating system OS1 is assigned one processor core, the virtual machine of the operating system OS2 two processor cores, and the operating system OS3 in turn one processor core by the virtualization layer 2.

The control device 1 includes an interface (not shown) to which the device to be controlled (e.g. drive support or gear shift) is connected for input/output of control data and/or monitoring data.

The individual operating systems OS1 and OS3 or the corresponding processor cores can preferably be started and ended depending on the range of functions needed. By dividing the functions among multiple operating systems, the robustness of all applications being executed simultaneously is increased, creation of a roadworthy condition is accelerated, and preferably implementation of legal requirements is assured.

The operating systems OS1, OS2, OS3 installed via the virtualization layer 2 are distinguished according to their application focus:
a. OS1: bicycle-specific applications
   applications for controlling and monitoring the device (e.g. electric drive support, gear shifting, monitoring of the battery or the load and operating condition of the electric drive support)
   applications that perform safety-relevant functions (e.g. measuring speed and tire pressure, managing and checking the light systems; corresponding display of vehicle information such as speed, tire pressure, error messages)
b. OS2: user-specific applications (user-installed applications such as apps, Internet applications, navigation applications, and the like)
c. OS3: system-specific applications (update applications, watchdog application, interface application for controlling the data communication between vehicle/bicycle and OS1 and OS2 or other OSs)

Preferably additionally connected to the interface can be:
one or more sensors that supply additional control data/monitoring data necessary for control and/or monitoring of the device(s); and/or
one or more sensors that supply safety-relevant data necessary for performing the safety-relevant functions; and/or
one or more input devices (e.g. touch sensor signal, switch signal, etc.) via which the user can enter control instructions for controlling the device(s), which are transmitted to the interface in the form of corresponding command data; and/or
one or more input devices (e.g. touch sensor signal, switch signal, etc.) via which the user can enter setting instructions for setting the user-specific applications, which are transmitted to the interface in the form of corresponding setting data; and/or
one or more communication adapters (e.g. GPS, Bluetooth, WiFi, GSM, etc.) for entering communication signal data, which supply communication data necessary for executing the user-specific applications; and/or
a data transmission device for transmission and installation of user-specific applications; and/or
one or more display devices for displaying information data outputted from the first and/or second operating system.

At least the data communication relating to the control data/monitoring data and safety-relevant data occurs exclusively indirectly via the operating system OS3.

The operating system (OS3) provides the other operating systems (OS1, OS2) with internal interfaces for this, and executes a corresponding interface application to realize the data communication.

The data flow of the data communication is shown in the FIGURE by the solid arrows.

The data flow shown in the FIGURE with dashed arrows concerns, with respect to the first operating system OS1, the data communication of the command data obtained from an input device, and with respect to the second operating system OS2, the setting data, which are likewise obtained from an input device. In this case, however, the operating system OS3 is configured to check the command data and setting data before executing the corresponding control instructions or setting instructions if their execution is permitted.

Preferably, however, the entire data exchange occurs indirectly via OS3, i.e. in the FIGURE along the solid arrows. In order to carry out the communication, the operating system OS3 or the interface application executed on it is configured to correspondingly control the virtualization layer.

In addition, preferably an access rights application also is executed on the operating system OS3 that determines which data the first and/or second operating system has access to or which data can be transmitted to the operating systems OS1, OS2.

Last of all, preferably a watchdog application is installed on the operating system OS3 that monitors the first operating system and/or the second operating system and, depending on this, can end and start the first and/or second operating system itself and/or applications that are executed on the first or second operating system. This watchdog application is preferably carried out in OS3 and monitors the general availability and utilization of the other operating systems (OS1, OS2) as well as of individual applications, which are executed by these operating systems, such as the display of information required by law: current speed or the warning light for the high beams, etc. The watchdog application can preferably cause the hypervisor 2 to end the execution of individual operating systems, restart them, or inform the monitored operating system via the internal interface to start or end a particular program or particular application.

With respect to output of the information data of the operating systems, the contents of several image memories (virtual frame buffer of OS1 and OS2) are merged by the hypervisor 2 in a single image memory (e.g. a physical frame buffer), which is then displayed on the screen of the display device.

In this embodiment, only a single processor or a single CPU is required, which means that no redundant memory (RAM, flash) or power supplies (for CPU/processor and memory) need to be kept available. This lowers production costs and makes such multi-operating system solutions also possible in markets exposed to high cost pressure (such as bicycles). Moreover, a) the required circuit board space and b) the power consumption are reduced compared to a possible implementation based on multiple CPUs/processors.

By separating the different operating systems, the operability of each individual operating system and of the applications/programs executed by the operating system is increased, and failures caused by dependencies between applications/programs are reduced. Dependencies between a user-specific application/program (e.g. navigation) and an application for a bicycle component/vehicle component (e.g. battery) are avoided because no interaction takes place and these subcomponents of the system do not corrupt each other. For example, the software watchdog monitors the clock speed (in Hz) of the processor cores demanded by OS1 and OS2. The higher the load on the CPU/processor is, the greater its power consumption is. An abrupt rise or excessive current consumption could be perceived by the control unit responsible for the power supply of the bicycle as a possible defect (e.g. short circuit) and cause the electronics of the bicycle as a whole to be switched off, thus making the bicycle unusable. This may well lead to dangerous situations (sudden loss of the electric drive support, failure of normal electronically activated shifting, failure of driver assistance systems such as ABS, etc.).

The watchdog application detects and prevents the occurrence of such a system state by timely ending and restarting of the responsible operating system or the respective process.

The smaller the range of functions of the operating system (e.g. hardware-near kernel driver), the number of program modules to be loaded (e.g. Bluetooth stack), or the complexity of a user interface (e.g. HTML), the lower is its memory consumption and the faster the operating system and applications can be loaded from memory (RAM and flash) and executed. By dividing the various functions among the different operating systems OS1 and OS2, safety-relevant functions can already be provided shortly after the system start (a cold start means applying a voltage) without having to wait for the loading of less important drivers or lower program codes not necessary for executing the system relevant functions.

For example, the current speed and the warning lights can be displayed quickly while the loading and executing of more complex functions (navigation applications, fitness applications, etc.) can take longer.

In a conventional architecture having only one operating system, the vehicle manufacturer, dealer or end user could manipulate the display of certain information required by law (conceal a display, modify a calculation, import a new program code, etc.). By dividing the applications among both operating systems OS1 and OS2 and executing the access rights application, i.e. the granting of access rights, this can be prevented.

The rapid creation of a system state suitable for the particular application purpose is also possible without use of conventional fast boot strategies in which a specific operating system state is stored in the volatile memory (flash memory) and the corresponding memory component must be powered for that. This can significantly reduce the capacity of an integrated battery.

The control device 1 can preferably already be programmed with OS1, OS2, and OS3 when it is manufactured, so that depending on the display device installed when the vehicle is manufactured, when the vehicle is sold by the dealer, or subsequently by the end customers, the OS3 of the control device 1 decides which operating systems (OS1, OS2) must be executed to be able to properly control the display device and record contents. A pure LCD interface or a wired remote control thus needs no output of contents that are calculated by the graphics processor. In this way, depending on the ultimate range of functions, processor cores not necessary can thus be deactivated, such as the execution of a higher-value operating system like Android as OS2. The power consumption is thus reduced considerably depending on the range of functions.

The solution according to the invention preferably assumes that hardware resources are shared, but furthermore very preferably concerns how a virtual instance (OS3) controls the other virtual instances (watchdog) and provides these instances (OS1, OS2) with access to data and commands depending on defined rights. For this, OS1 and OS2 only communicate indirectly with the bicycle; instead, these two operating systems use only interfaces provided to them by OS3 (interface application). OS3 is the only operating system that communicates directly—or via the IPC—with the on-board power system. In this way, safety-critical data and functions, or those only to be made visible with restrictions according to a defined rights model, are controlled solely by OS3 as a central instance. The on-board power system-related command and data flow is thus first processed/filtered by an OS3 central instance.

The central instance OS3 recognizes, based on requests/samples executed at regular intervals, whether the other instances (OS1 and OS2) correspond to the operating state required by OS3. If OS3 determines an operating state requiring an action (e.g. OS2 is frozen because a navigation application no longer responds to user input), OS3 can instruct the virtualization layer to provide shared resources (input and output) to the sampled operating system to a restricted extent or not at all (e.g. the display of OS1 can occupy the full screen if OS3 determines that OS2 no longer responds to screen inputs). OS3 can thus instruct the virtualization layer, during the boot process, to display the screen content of OS1 full-screen and only after successful, complete boot of OS2 use a screen arrangement in which OS1 and OS2 are shown at the same time.

1-18. (canceled)

19. A control device for a bicycle having at least one device that influences the driving properties of the bicycle, wherein
the control device has an electronic controller configured
to execute in parallel a first operating system (OS1) and a second operating system (OS2), wherein
on the first operating system (OS1) during intended operation of the control device, at least one application is executed for controlling and/or monitoring the device that influences the driving properties of the bicycle, and
on the second operating system (OS2), user-specific applications are executed during intended operation of the control device,
wherein
the electronic controller is configured to execute a third operating system (OS3) on which system-specific applications are executed,
the system-specific applications that are executed on the third operating system control the first and/or second operating system and
that comprise a watchdog application that is operated permanently and that monitors the first operating system and/or the second operating system and, depending on this, can end and start the first and/or second operating system itself and/or applications that are executed on the first or second operating system.

20. The control device according to claim 19, wherein
on the first operating system (OS1) during intended operation of the control device a plurality of applications are executed, each for con-trolling and/or monitoring one of a plurality of devices influencing the driving properties of the bicycle.

21. The control device according to claim 19, wherein
in addition, one or more applications that perform safety-relevant functions are executed on the first operating system (OS1) during in-tended operation of the control device.

22. The control device according to claim 19, wherein
the control device has an interface to which the device(s) for the input/output of control data and/or monitoring data can be connected.

23. The control device according to claim 22, wherein
one or more sensors that provide additional control data/monitoring data necessary for control and/or monitoring of the device(s); and/or
one or more sensors that provide safety-relevant data necessary for performing the safety-relevant functions; and/or
one or more input devices via which the user can enter control instructions for controlling the device(s) that are passed to the interface in the form of corresponding command data; and/or
one or more communication adapters for entering communication signal data providing the communication data necessary for executing the user-specific applications; and/or
one or more input devices via which the user can enter set-ting instructions for setting the user-specific applications that are transmitted to the interface in the form of corresponding setting data; and/or
a data transmission device for transmission and installation of the user-specific applications; and/or
one or more display devices for displaying information data that are outputted by the first and/or second operating system;
can be connected to the interface.

24. The control device according to claim 19, wherein
the system-specific applications that are executed on the third operating system, for controlling the first and/or second operating system, further include:
(i) an interface application that controls the data communication
between the first and/or second operating system and the de-vice(s), and/or
between the first and/or second operating system and the sensors, and/or
between the first and/or second operating system and the input device(s), and/or
between the first and/or second operating system and the communication adapter;
(ii) an access rights application that defines the data to which the first and/or second operating system has access.

25. The control device according to claim 24, wherein
the interface function application is configured to perform an authentication of the first and/or second operating system and to prohibit the data communication when the authentication fails.

26. The control device according to claim 19, wherein the controller has a virtualization layer, preferably a hypervisor, at least between the electronic controller and a first virtual machine on which the first operating system is running, and a second virtual machine on which the second operating system is running, wherein
the third operating system for controlling the first and/or second operating system is configured to control the virtualization layer.

27. The control device according to claim 26, wherein the virtualization layer is also located between the electronic controller and a third virtual machine on which the third operating system is running, and the third operating system for controlling the first and/or second operating system is configured to control the virtualization layer.

28. The control device according to claim 26, wherein
the electronic controller has a CPU having a plurality of processor cores and the virtualization layer assigns at least one processor core to each virtual machine.

29. The control device according to claim 28, wherein
the watchdog application monitors the first operating system and/or the second operating system by monitoring a load of the processor core of the first virtual machine and/or the second virtual machine, and depending on this ends and starts the first and/or second operating system itself and/or applications that are executed on the first and/or second operating system.

30. The control device according to claim 26, wherein the interface application controls the data communication by correspondingly controlling the virtualization layer.

31. The control device according to claim 30, wherein the third operating system provides an internal interface for the first and second operating systems and the interface application is configured such that at least the data communication containing the control data and safety-relevant data is carried out exclusively via the internal interface.

32. The control device according to claim 30, wherein the interface application controls the data communication by controlling the virtualization layer such that data in an interface memory that is as-signed to the first and/or the second virtual machine by the virtualization layer are checked before transmission to the respective operating system.

33. The control device according to claim 26, wherein
the virtualization layer assigns to the first operating system a first virtual frame memory for storing the corresponding information data and to the second operating system a second virtual frame memory for storing the corresponding information data; and
the virtualization layer merges the information data from the first and second frame memories in a third frame memory prior to output to the display device for the shared display on the display device.
